(19) United States
(12) Patent Application Publication
(10) Pub. No.: US 2018/0215661 A1
(43) Pub. Date: Aug. 2, 2018

(54) LED CURING OF HIGH MODULUS FIBER COATING

(71) Applicant: Corning Incorporated, Corning, NY (US)

(72) Inventors: Inna Igorevna Kouzmina, Corning, NY (US); Darren Andrew Stainer, Wrightsville, NC (US)

(21) Appl. No.: 15/873,277

(22) Filed: Jan. 17, 2018

Related U.S. Application Data
(60) Provisional application No. 62/451,138, filed on Jan. 27, 2017.

(51) Int. Cl. C03C 25/105; C09D 4/00; C03B 37/025; C03C 25/1065; G02B 6/036; G02B 6/02

(52) U.S. Cl. CPC C03C 25/105; C09D 4/00; C03B 37/025; C03C 25/1065; G02B 6/4403; G02B 6/02395; C03C 2218/32; C03C 2217/78; G02B 6/036

(57) ABSTRACT

Curable coating compositions having a high degree of cure and high modulus upon excitation with an LED or laser source are described. The curable coating compositions include one or more radiation-curable monomers and one or more photoinitiators. The curable coating compositions are preferably devoid of oligomers. The LED or laser source preferably provides UV radiation having a peak wavelength in the range from 360 nm-410 nm.

This application claims the benefit of priority under 35 U.S.C. § 119 of U.S. Provisional Application Ser. No. 62/451,138 filed on Jan. 27, 2017 the content of which is relied upon and incorporated herein by reference in its entirety.

### FIELD

This description pertains to coatings for optical fiber and methods of making coatings for optical fibers. More particularly, this description relates to methods of curing coating compositions using LED light sources operating at UV wavelengths and cured coatings made by the methods.

### BACKGROUND

The light transmitting performance of an optical fiber is highly dependent upon the properties of the polymer coating that is applied to the glass fiber during manufacturing. Typically a dual-layer coating system is used where a soft (low modulus) primary coating is in contact with the glass fiber and a hard (high modulus) secondary coating surrounds and contacts the primary coating. The secondary coating provides mechanical integrity and allows the optical fiber to be handled and further processed, while the primary coating plays a key role in dissipating external forces and preventing them from being transferred to the glass fiber where they can cause damage or attenuation of optical signals.

The functional requirements of the primary coating place several constraints on the materials that are used for these coatings. In order to prevent bending and other external mechanical disturbances from inducing losses in the intensity of the optical signal transmitted through the fiber, the Young's modulus of the primary coating must be as low as possible (generally less than 1 MPa, and ideally less than 0.5 MPa). To ensure that the modulus remains low when the fiber is exposed to low temperatures during deployment in cold climates, the glass transition temperature of the primary coating must be low (generally less than 0° C., and preferably less than −20° C.) so that the primary coating does not transform to a rigid glassy state. Also, the tensile strength of the primary coating, must be high enough to prevent tearing defects when drawing the fiber or during post-draw processing of the coated fiber (e.g. when applying ink layers or bundling the fiber to form cables). To ensure uniformity in the thickness of the primary coating, the composition from which the primary coating is formed is applied to the fiber in liquid form. A liquid primary coating composition flows to provide uniform coverage of the fiber to promote uniformity of thickness in the cured state.

The secondary coating must have sufficient stiffness to protect the glass fiber and sufficient flexibility to enable handling without breaking. The secondary coating should also have low water absorption, low tackiness, mechanical and chemical durability, low coefficient of friction to enable winding on spools, and good adhesion to the primary coating. To ensure suitable mechanical integrity, the glass transition temperature of the secondary coating must be relatively high (generally above 40° C., and preferably above 50° C.) so that the secondary coating remains in a rigid glassy state throughout the range of expected deployment temperatures. As with the primary coating composition, it is beneficial to employ a liquid phase secondary coating composition to facilitate uniform coverage of the secondary coating composition on the primary coating and uniform thickness of the secondary coating in the cured state.

In optical fiber manufacturing, the glass fiber is drawn from a heated preform and sized to a target diameter (typically 125 μm). The draw speed of the fiber is greater than 30 m/s, or greater than 35 m/s, or greater than 40 m/s, or greater than 45 m/s, or greater than 50 m/s. The glass fiber is then cooled and directed to a coating system that applies a liquid primary coating composition to the glass fiber. Two process options are viable after application of the liquid primary coating composition to the glass fiber. In one process option (wet-on-dry process), the liquid primary coating composition is cured to form a solidified primary coating, the liquid secondary coating composition to the primary coating, and the liquid secondary coating composition is cured to form a solidified secondary coating. In a second process option (wet-on-wet process), the liquid secondary coating composition is applied to the liquid primary coating composition, and both liquid coating compositions are cured simultaneously to provide solidified primary and secondary coatings.

Commercial manufacturing processes produce optical fibers in a continuous process. The glass fiber is drawn from the preform, sized, coated, and collected in a continuous manner. To improve process efficiency, draw speed needs to be high. High draw speeds necessitate use of coating compositions that cure quickly. Fast cure rates are achieved through free radical polymerization processes that are most commonly initiated photochemically. A photoinitiator is excited by radiation of a suitable wavelength to produce an intermediate free radical compound that reacts with one or more components in the coating composition to initiate curing. Once initiated, polymerization proceeds through propagation to extend chain length, and termination to conclude the reaction.

Common photoinitiator compounds are excited with UV (ultraviolet) radiation. Hg lamps are conventionally used as sources of UV radiation. Hg lamps provide broad spectral coverage extending from UV wavelengths to IR (infrared) wavelengths. Although Hg lamps are effective for exciting a variety of photoinitiator compounds, they suffer from several disadvantages. First, Hg lamps require high power to generate UV radiation of sufficient intensity to initiate the photochemical reaction. The high powers lead to high operating costs and variability in the output intensity. Second, most of the radiation emitted by Hg lamps is at wavelengths outside of the absorption band of the photoinitiator. Typically, UV absorption bands of the photoinitiator is excited to initiate the curing reaction. Hg lamps, however, emit significant amounts of radiation in the visible and infrared. The visible and infrared radiation accounts for ˜90% of the radiation emitted by the Hg lamp and represents wasted energy. The infrared radiation leads to the further problem of heating the Hg lamp. To avoid overheating, it is necessary to cool the Hg lamp. Cooling necessitates use of a heat exchanger or other mechanism that adds to the cost and complexity of the Hg lamp. Heat generated by the Hg lamp also increases the temperature of the coating compositions and can alter the curing reaction in undesirable ways. There is accordingly a need to develop new sources of UV radiation that provide more efficient and cost-effective excitation of photoinitiators in primary and secondary coating compositions.

To achieve desired coating properties at high cure speeds, compositions for primary and secondary coatings have traditionally been formulated as mixtures of radiation-curable urethane acrylate oligomers and radiation-curable acrylate functional diluent monomers. Initiation is preferably induced with UV radiation. Upon exposure to UV light in the presence of a UV-absorbing photoinitiator, the acrylate groups of the radiation-curable oligomers and monomers rapidly polymerize to form a polymer network. The modulus of the network is controlled through the degree of crosslinking and the extent of hydrogen bonding interactions between urethane groups. By varying the chemical identity and concentration of urethane acrylate oligomer(s), it is possible to form primary coatings having very low modulus values while still providing sufficient tensile strength to minimize damage during the draw or post-draw processing and to form secondary coatings having high modulus, flexibility, and durability.

A drawback of common secondary coatings is the need for a high concentration of urethane acrylate oligomers in the secondary coating composition. The high oligomer concentration is needed to ensure that the secondary coating formed by curing the secondary coating composition has a degree of crosslinking sufficient to provide high modulus and mechanical integrity. The urethane acrylate oligomers needed for secondary coatings, however, are specialty compounds that are expensive and available only in limited supply. There is accordingly a need to develop secondary coating compositions that have low or no oligomer content.

Modification of the secondary coating composition, however, will affect the reaction process and initiation requirements. Photoinitiators capable of initiating conventional urethane acrylate oligomers may be unsatisfactory for initiating compounds that replace urethane acrylate oligomers in the secondary coating composition. The excitation wavelength needed to initiate a reformulated secondary coating composition may also change. In light of the need to identify alternatives to Hg lamps, it is therefore desirable to develop radiation-curable secondary coating compositions with little or no oligomer content that cure quickly with high efficiency UV radiation sources to provide secondary coatings having the modulus and mechanical strength needed for optical fibers.

### SUMMARY

The present description provides a method for curing a secondary coating composition having low or no oligomer content. The secondary coating composition includes two or more acrylate monomers and a photoinitiator. The secondary coating composition optionally includes additives such as an antioxidant, a slip additive, a tackifier, an adhesion promoter, a lubricant, a catalyst, and a stabilizer. Curing is accomplished with a UVLED (ultraviolet light emitting diode) source. The method provides fast curing of a secondary coating composition having low or no oligomer content and provides secondary coatings with a high degree of cure.

The present disclosure extends to:
A method for manufacturing an optical fiber comprising:

applying a coating composition to a glass fiber, said coating composition comprising: two or more radiation-curable monomers;
an oligomer, said oligomer having a concentration in the range from 0 wt %-3 wt % in said coating composition; and
a photoinitiator; and

curing said coating composition with a light emitting diode, said light emitting diode having an emission spectrum with a peak wavelength in the range from 360 nm-410 nm, said curing forming a cured product having an overall degree of cure greater than 80%.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic view of a coated optical fiber according one embodiment

FIG. 2 is a schematic view of a representative optical fiber ribbon.

FIG. 3 depicts the emission spectra of an Hg (mercury) lamp and several LED sources.

FIG. 4 depicts the absorption spectrum of the photoinitiator Lucirin TPO at two concentrations.

FIG. 5 depicts the absorption spectrum of the photoinitiator Irgacure 184 at three concentrations.

FIG. 6 shows the dose-modulus curve of a secondary coating composition upon excitation with an Hg lamp and several LED sources.

FIG. 7 shows damage resistance of three fiber samples.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

The term “(meth)acrylate” means acrylate, methacrylate, or a combination of acrylate and methacrylate.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening elements. Elements in contact may be rigidly or non-rigidly joined. Contacting refers to placing two elements in direct or indirect contact. Elements in direct (indirect) contact may be said to directly (indirectly) contact each other.

In various embodiments herein, a coating composition is applied to an element. As used herein, applying refers to placing the coating composition in contact with the element. A coating composition applied to an element is in contact with the element. The terms “directly apply” or “directly applied” mean that when the coating composition is applied to the element, it is placed in direct contact with the element.

The coatings described herein are formed from curable coating compositions. Curable coating compositions include one or more curable components. As used herein, the term “curable” is intended to mean that the component, when exposed to a suitable source of curing energy, includes one or more curable functional groups capable of forming covalent bonds that participate in linking the component to itself or to other components to form a polymeric coating material. The product obtained by curing a curable coating composition may be referred to herein as the cured product of the composition. The curing process may be induced by energy. Forms of energy include radiation or thermal energy. A radiation-curable component is a component that can be induced to undergo a curing reaction when exposed to radiation of a suitable wavelength at a suitable intensity for a sufficient period of time. The radiation curing reaction preferably occurs in the presence of a photoinitiator. A radiation-curable component may also optionally be thermally curable. Similarly, a thermally-curable component is a component that can be induced to undergo a curing reaction when exposed to thermal energy of sufficient intensity for a sufficient period of time. A thermally curable component may also optionally be radiation curable.

A curable component may include one or more curable functional groups. A curable component with only one curable functional group is referred to herein as a monofunctional curable component. A curable component having two or more curable functional groups is referred to herein as a multifunctional curable component or a polyfunctional curable component. Multifunctional curable components include two or more functional groups capable of forming covalent bonds during the curing process and can introduce crosslinks into the polymeric network formed during the curing process. Multifunctional curable components are also referred to herein as “crosslinkers” or “curable crosslinkers”. Examples of functional groups that participate in covalent bond formation during the curing process are identified hereinafter.

In the description that follows, various components of coating compositions will be discussed and the amounts of particular components in the coating composition will be specified in terms of weight percent (wt %) or parts per hundred (pph). The components of the coating composition include base components and additives. The concentration of base components will be expressed in terms of wt % and the concentration of additives will be expressed in terms of pph.

As used herein, the weight percent of a particular base component refers to the amount of the component present in the coating composition on a basis that excludes additives. The additive-free coating composition includes only base components and is referred to herein as a base composition or base coating composition. Base components are limited to curable components and photoinitiators. Curable components include one or more curable monomers. In one embodiment, the coating composition is devoid of curable oligomers. In another embodiment, the coating composition includes a low concentration of one or more curable oligomers. If present, curable oligomers are regarded as base components and as constituents of the base composition and amounts of curable oligomers will be expressed as weight percent. The base composition minimally includes a radiation-curable monomer component and a photoinitiator. The collective amount of base components in a coating composition is regarded herein as equaling 100 wt %.

Additives are optional. Examples of additives include one or more of a UV absorber, an adhesion promoter, an antioxidant, a catalyst, a carrier or surfactant, a tackifier, a stabilizer, an amine synergist, and an optical brightener. Representative additives are described in more detail hereinbelow. The amount of additives introduced into the coating composition is expressed herein in parts per hundred (pph) relative to the base composition. For example, if 1 g of a particular additive is added to 100 g of base composition, the concentration of additive will be expressed herein as 1 pph.

Reference will now be made in detail to illustrative embodiments of the present description.

The present description provides a method for curing coating compositions, coatings formed by curing the coating compositions, methods for forming coatings on optical fibers, and coated optical fibers. In one embodiment, the coating compositions are radiation-curable coating compositions. In another embodiment, the cured product of the coating composition has properties that meet the requirements needed for secondary coatings for optical fibers.

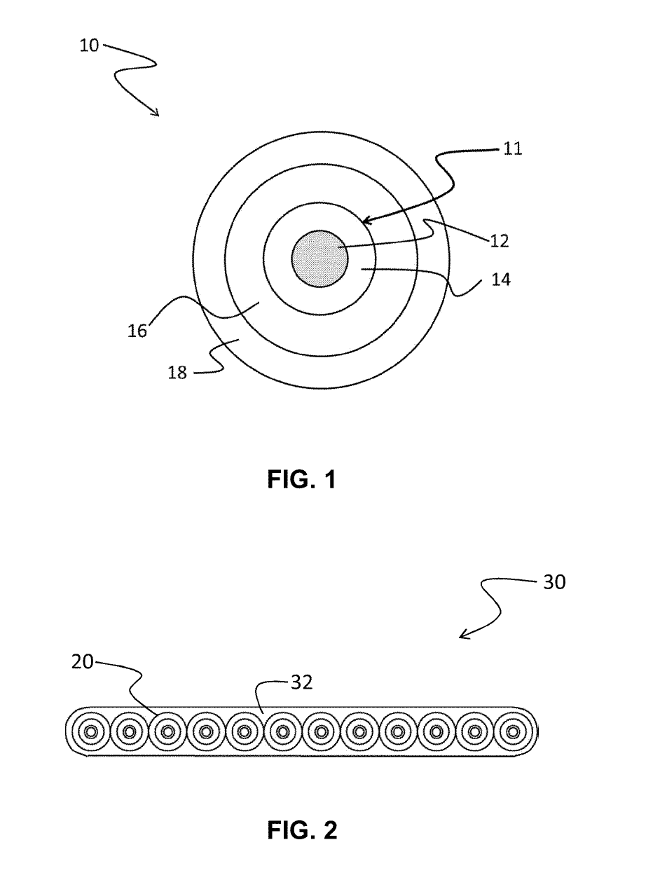

An example of a coated optical fiber is shown in schematic cross-sectional view in FIG. 1. Coated optical fiber 10 includes a glass optical fiber 11 surrounded by primary coating 16 and secondary coating 18. Glass fiber 11 includes a core 12 and a cladding 14. Core 12 and cladding 14 differ in refractive index, with core 12 having a higher average refractive index than cladding 14. Cladding 14 includes a single layer or a combination of two or more layers, where each layer is distinguished from other layers by a difference in refractive index. Examples of refractive index profiles for glass fiber 11 include step index profiles and graded index profiles. Coated optical fiber 10 is a single mode fiber or a multimode fiber.

FIG. 2 illustrates an optical fiber ribbon 30. The ribbon 30 includes a plurality of optical fibers 20 and a matrix 32 encapsulating the plurality of optical fibers. Optical fibers 20 include a core glass region, a cladding glass region, a primary coating, and a secondary coating. Optical fibers 20 may also include an ink layer. The secondary coating may include a pigment. The optical fibers 20 are aligned relative to one another in a substantially planar and parallel relationship. It is desirable that optical fibers 20 are not displaced from a common plane by a distance of more than about one-half the diameter thereof. The optical fibers in fiber optic ribbons may be encapsulated by the ribbon matrix 32 in any known configuration (e.g., edge-bonded ribbon, thin-encapsulated ribbon, thick-encapsulated ribbon, or multi-layer ribbon) by conventional methods of making fiber optic ribbons. In FIG. 2, the fiber optic ribbon 30 contains twelve (12) optical fibers 20; however, it should be apparent to those skilled in the art that any number of optical fibers 20 (e.g., two or more) may be employed to form fiber optic ribbon 30 disposed for a particular use. The ribbon matrix 32 can be formed from the same composition used to prepare a secondary coating, or the ribbon matrix 32 can be formed from a different composition that is otherwise compatible for use. In one embodiment, the ribbon matrix 32 is or is similar to a secondary coating, including cured products of secondary coating compositions described herein.

The cured product of a curable coating composition in accordance with the present description can function as a secondary coating for an optical fiber or as a ribbon matrix for an optical fiber ribbon. The curable coating composition used is preferably a radiation-curable liquid composition. The radiation-curable coating composition includes one or more monomers and one or more photoinitiators. The radiation-curable coating composition optionally includes one or more oligomers. As used herein, the term “oligomer” refers to a compound with urethane linkages that is the reaction product of a polyol compound, a diisocyanate compound, and a hydroxy-functional acrylate compound. Reaction of the polyol compound with the diisocyanate compound provides a urethane linkage and the hydroxy-functional acrylate compound reacts with isocyanate groups to provide terminal acrylate groups. If present, the total oligomer content in the radiation-curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %. In one embodiment, the radiation-curable coating composition is devoid of oligomers. The radiation-curable coating composition also optionally includes additives such as anti-oxidant(s), optical brightener(s), amine synergist(s), tackifier(s), catalyst(s), a carrier or surfactant, and a stabilizer.

The coating is formed as the cured product of a radiation-curable coating composition that includes a monomer component with one or more monomers. The monomers preferably include ethylenically unsaturated compounds. The one or more monomers may be present in an amount of 50 wt % or greater, or in an amount from about 60 wt % to about 99 wt %, or in an amount from about 75 wt % to about 99 wt %, or in an amount from about 80 wt % to about 99 wt % or in an amount from about 85 wt % to about 99 wt %. In one embodiment, the coating is the radiation-cured product of a coating composition that contains urethane acrylate monomers.

In one embodiment, the monomer component of the curable coating composition includes ethylenically unsaturated monomers. The monomers include functional groups that are polymerizable groups and/or groups that facilitate or enable crosslinking. The monomers are monofunctional monomers or polyfunctional monomers. In combinations of two or more monomers, the constituent monomers are monofunctional monomers, polyfunctional monomers, or a combination of monofunctional monomers and polyfunctional monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

Exemplary monofunctional ethylenically unsaturated monomers for the curable coating composition include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxyethyl acrylate, phenoxyethyl acrylate (e.g., SR339, Sartomer Company, Inc.), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bomyl acrylate, isobornyl acrylate (e.g., SR423, Sartomer Company, Inc.), tetrahydrofiurfuryl acrylate (e.g., SR285, Sartomer Company, Inc.), caprolactone acrylate (e.g., SR495, Sartomer Company, Inc.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4) nonylphenol acrylate (e.g., Photomer 4066, IGM Resins); acrylamides such as diacetone acrylamide, isobutoxymethyl acrylamide, N,N′-dimethyl-aminopropyl acrylamide, N,N-dimethyl acrylamide, N,N diethyl acrylamide, and t-octyl acrylamide; vinylic compounds such as N-vinylpyrrolidone and N-vinylcaprolactam; and acid esters such as maleic acid ester and fumaric acid ester. With respect to the long and short chain alkyl acrylates listed above, a short chain alkyl acrylate is an alkyl group with 6 or less carbons and a long chain alkyl acrylate is an alkyl group with 7 or more carbons.

Representative radiation-curable ethylenically unsaturated monomers included alkoxylated monomers with one or more acrylate or methacrylate groups. An alkoxylated monomer is one that includes one or more alkoxylene groups, where an alkoxylene group has the form —O—R— and R is a linear or branched hydrocarbon. Examples of alkoxylene groups include ethoxylene (—O—CH₂—CH₂—), n-propoxylene (—O—CH₂—CH₂—CH₂—), isopropoxylene (—O—CH₂—CH(CH₃)—), etc. As used herein, the degree of alkoxylation refers to the number of alkoxylene groups in the monomer. In one embodiment, the alkoxylene groups are bonded consecutively in the monomer.

Representative polyfunctional ethylenically unsaturated monomers for the curable coating composition include, without limitation, alkoxylated bisphenol A diacrylates, such as ethoxylated bisphenol A diacrylate, with the degree of alkoxylation being 2 or greater. The monomer component of the secondary composition may include ethoxylated bisphenol A diacrylate with a degree of ethoxylation ranging from 2 to about 30 (e.g. SR349 and SR601 available from Sartomer Company, Inc. West Chester, Pa. and Photomer 4025 and Photomer 4028, available from IGM Resins), or propoxylated bisphenol A diacrylate with the degree of propoxylation being 2 or greater; for example, ranging from 2 to about 30; methylolpropane polyacrylates with and without alkoxylation such as ethoxylated trimethylolpropane triacrylate with the degree of ethoxylation being 3 or greater; for example, ranging from 3 to about 30 (e.g., Photomer 4149, IGM Resins, and SR499, Sartomer Company, Inc.); propoxylated-trimethylolpropane triacrylate with the degree of propoxylation being 3 or greater; for example, ranging from 3 to 30 (e.g., Photomer 4072, IGM Resins and SR492, Sartomer); ditrimethylolpropane tetraacrylate (e.g., Photomer 4355, IGM Resins); alkoxylated glyceryl triacrylates such as propoxylated glyceryl triacrylate with the degree of propoxylation being 3 or greater (e.g., Photomer 4096, IGM Resins and SR9020, Sartomer); erythritol polyacrylates with and without alkoxylation, such as pentaerythritol tetraacrylate (e.g., SR295, available from Sartomer Company, Inc. (West Chester, Pa.)), ethoxylated pentaerythritol tetraacrylate (e.g., SR494, Sartomer Company, Inc.), and dipentaerythritol pentaacrylate (e.g., Photomer 4399, IGM Resins, and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.) and ethoxylated polyethylene glycol diacrylate with the degree of ethoxylation being 2 or greater; for example, ranging from about 2 to 30; epoxy acrylates formed by adding acrylate to bisphenol A diglycidylether and the like (e.g., Photomer 3016, IGM Resins); and single and multi-ring cyclic aromatic or non-aromatic polyacrylates such as dicyclopentadiene diacrylate and dicyclopentane diacrylate.

The curable coating composition may or may not include an oligomeric component. One or more oligomers may be optionally present in the curable coating composition. One class of oligomers that may be included is ethylenically unsaturated oligomers. When employed, suitable oligomers may be monofunctional oligomers, polyfunctional oligomers, or a combination of a monofunctional oligomer and a polyfunctional oligomer. If present, the oligomer component may include aliphatic and aromatic urethane (meth)acrylate oligomers, urea (meth)acrylate oligomers, polyester and polyether (meth)acrylate oligomers, acrylated acrylic oligomers, polybutadiene (meth)acrylate oligomers, polycarbonate (meth)acrylate oligomers, and melamine (meth)acrylate oligomers or combinations thereof. The curable coating composition may be free of urethane groups, urethane acrylate compounds, urethane oligomers, or urethane acrylate oligomers.

The optional oligomeric component of the curable coating composition may include a difunctional oligomer. A difunctional oligomer may have a structure according to formula (I) below:

F₁—R₁-[urethane-R₂-urethane]ₘ-R₁—F₁ (I)

where F₁ may independently be a reactive functional group such as acrylate, methacrylate, acrylamide, N-vinyl amide, styrene, vinyl ether, vinyl ester, or other functional group known in the art; R₁ may include, independently, —C₂₋₁₂ O—, —(C₂₋₄—O)ₙ—, —C₂₋₁₂ O—(C₂₋₄—O)ₙ—, —C₂₋₁₂ O—(CO—C₂₋₅ O)ₙ—, or —C₂-₁₂ O—(CO—C₂₋₅NH)ₙ— where n is a whole number from 1 to 30, including, for example, from 1 to 10; R₂ may be a polyether, polyester, polycarbonate, polyamide, polyurethane, polyurea, or combination thereof; and m is a whole number from 1 to 10, including, for example, from 1 to 5. In the structure of formula (I), the urethane moiety may be the residue formed from the reaction of a diisocyanate with R₂ and/or R₁. The term “independently” is used herein to indicate that each F₁ may differ from another F₁ and the same is true for each R₁.

The optional oligomer component of the curable coating composition may include a polyfunctional oligomer. The polyfunctional oligomer may have a structure according to formula (II), formula (III), or formula (IV) set forth below:

multiurethane-(F₂—R₁—F₂)ₓ (II)

polyol-[(urethane-R₂-urethane)ₘ-R₁—F₂]ₓ (III)

multiurethane-(R₁—F₂)ₓ (IV)

where F₂ may independently represent from 1 to 3 functional groups such as acrylate, methacrylate, acrylamide, N-vinyl amide, styrene, vinyl ether, vinyl ester, or other functional groups known in the art; R₁ can include —C₂₋₁₂ O—, —(C₂₋₄—O)ₙ—, —C₂₋₁₂ O—(C₂₋₄—O)ₙ—, —C₂₋₁₂ O—(CO—C₂₋₅ O)ₙ—, or —C₂₋₁₂ O—(CO—C₂₋₅NH)ₙ— where n is a whole number from 1 to 10, including, for example, from 1 to 5; R₂ may be polyether, polyester, polycarbonate, polyamide, polyurethane, polyurea or combinations thereof; x is a whole number from 1 to 10, including, for example, from 2 to 5; and m is a whole number from 1 to 10, including, for example, from 1 to 5. In the structure of formula (II), the multiurethane group may be the residue formed from reaction of a multiisocyanate with R₂. Similarly, the urethane group in the structure of formula (III) may be the reaction product formed following bonding of a diisocyanate to R₂ and/or R₁.

Urethane oligomers may be prepared by reacting an aliphatic or aromatic diisocyanate with a dihydric polyether or polyester, most typically a polyoxyalkylene glycol such as a polyethylene glycol. Moisture-resistant oligomers may be synthesized in an analogous manner, except that polar polyethers or polyester glycols are avoided in favor of predominantly saturated and predominantly nonpolar aliphatic diols. These diols may include alkane or alkylene diols of from about 2-250 carbon atoms that may be substantially free of ether or ester groups.

If present, the total oligomer content in the radiation-curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %. The total urethane oligomer content in the radiation-curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %. In one embodiment, the radiation-curable coating composition is devoid of urethane oligomers. In another embodiment, the cured product of the radiation-curable coating composition lacks urethane groups.

Polyurea elements may be incorporated in oligomers prepared by these methods, for example, by substituting diamines or polyamines for diols or polyols in the course of synthesis.

The curable coating composition also includes one or more polymerization initiator to facilitate polymerization (curing) of the curable coating composition to form a cured product (e.g. a secondary coating for an optical fiber or ribbon matrix of an optical fiber ribbon). In a preferred embodiment, the polymerization initiator is a photoinitiator. A radiation-curable coating composition includes one photoinitiator, or one or more photoinitiators, or two photoinitiators, or two or more photoinitiators.

For many acrylate-based coating formulations, photoinitiators, such as the known ketonic photoinitiating and/or phosphine oxide additives, are used. Suitable photoinitiators for the radiation-curable secondary coating composition include, without limitation, 2,4,6-trimethylbenzoyl-diphenylphosphine oxide (e.g. Lucirin TPO); 1-hydroxycyclohexylphenyl ketone (e.g. Irgacure 184 available from BASF); (2,6-diethoxybenzoyl)-2,4,4-trimethylpentyl phosphine oxide (e.g. in commercial blends Irgacure 1800, 1850, and 1700, BASF); 2,2-dimethoxyl-2-phenyl acetophenone (e.g., Irgacure,651, BASF); bis(2,4,6-trimethylbenzoyl)phenyl phosphine oxide (e.g., Irgacure 819, BASF); (2,4,6-triiethylbenzoyl)diphenyl phosphine oxide (e.g., in commercial blend Darocur 4265, BASF); 2-hydroxy-2-methyl-1-phenylpropane-1-one (e.g., in commercial blend Darocur 4265, BASF) and combinations thereof.

The amount of photoinitiator(s) is adjusted to promote radiation curing to provide reasonable cure speed without causing premature gelation of the radiation-curable coating composition. A desirable cure speed may be a speed sufficient to cause curing of the radiation-curable coating composition to a degree of cure sufficient to form a cured product with mechanical properties (e.g. Young's modulus, tensile strength, % elongation) suitable to use as a secondary coating, an ink coating, or pigmented coating for an optical fiber or as a matrix material for an optical fiber ribbon.

The total concentration of photoinitiator(s) in the radiation-curable composition is in the range from 0.5 wt %-10 wt %, or in the range from 1.0 wt %-7.5 wt %, or in the range from 1.5 wt %-5.0 wt %, or in the range from 2.0 wt %-4.0 wt %.

In embodiments in which two or more photoinitiators are present in the coating composition, the absorption intensity of the different photoinitiators differs at a particular wavelength or over a range of wavelengths. Absorption intensity over a range of wavelengths is measured as the integrated absorption intensity over the range of wavelengths for the photoinitiator in the coating composition. In one embodiment, the coating composition includes two or more photoinitiators where the two or more photoinitiators include one photoinitiator with an integrated absorbance over the wavelength range from 380 nm-410 nm that is at least ten times greater than the integrated absorbance over the wavelength range from 380 nm-410 nm of another photoinitiator.

In addition to the above-described components, the curable coating composition may optionally include an additive or a combination of additives. Representative additives include, without limitation, antioxidants, catalysts, lubricants, low molecular weight non-crosslinking resins, adhesion promoters, slip agent, and stabilizers. Additives may operate to control the polymerization process, thereby affecting the physical properties (e.g., modulus, glass transition temperature) of the polymerization product formed from the composition. Additives may affect the integrity of the polymerization product of the composition (e.g., protect against de-polymerization or oxidative degradation).

Preferred antioxidants include, without limitation, bis hindered phenolic sulfide or thiodiethylene bis(3,5-di-tert-butyl)-4-hydroxyhydrocinnamate (e.g. Irganox 1035, available from BASF), 2,6-di-t-butyl-4-methylphenol (BHT) and MEHQ (monomethyl ether hydroquinone). The antioxidant, if present, is used in an amount between about 0.1 to about 3 pph, more preferably about 0.25 to about 2 pph.

A preferred adhesion promoter is an acrylated acid adhesion promoter (e.g. Ebecryl 170 (available from UCB Radcure (Smyrna Ga.)). A preferred slip agent is DC 190 (silicone-ethylene oxide/propylene oxide copolymer, available from Dow Corning).

One preferred stabilizer is a tetrafunctional thiol, e.g., pentaerythritol tetrakis(3-mercaptopropionate) from Sigma-Aldrich (St. Louis, Mo.). The stabilizer, if present, is used in an amount between about 0.01 pph to about 1 pph, more preferably about 0.01 pph to about 0.2 pph.

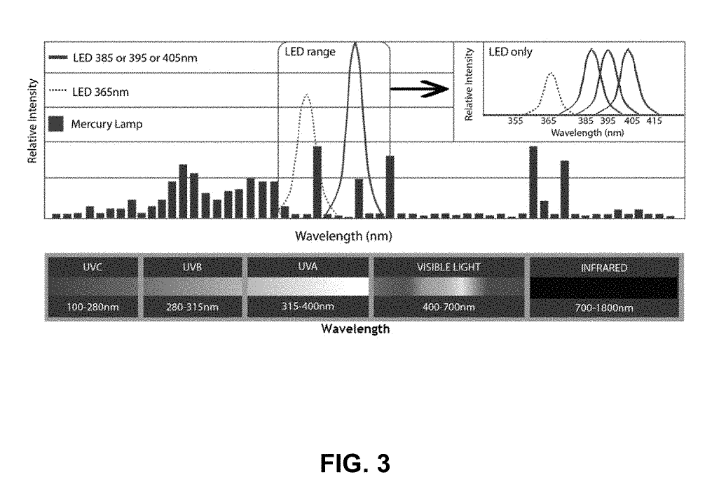

Initiation of the radiation curing process of the curable coating composition occurs by exciting the photoinitiator(s) with a suitable wavelength. Absorption bands of the photoinitiator(s) determine suitable wavelengths for excitation. Excitation of the photoinitiator(s) is conventionally accomplished with a broadband excitation source that emits over a wide range of wavelengths. Many photoinitiators require excitation in the UV (ultraviolet), for example, and excitation is typically accomplished with an Hg (mercury) lamp. The emission spectrum of an Hg lamp is shown in FIG. 3. The emission spectrum includes a series of spectral lines that extend over the wavelength range from 100 nm-1800 nm as indicated. The most common photoinitiators require excitation in the UVA range (315 nm-400 nm) and the emission spectrum of an Hg lamp includes several wavelengths in the UVA range with adequate intensity to excite such photoinitiators.

Although Hg lamps are effective at exciting many photoinitiators, the broad spectral output of Hg lamps produces many wavelengths that are not utilized in the excitation of a particular photoinitiator. As a result, much of the power used to operate is lost and represents wasted energy. The efficiency of excitation is accordingly low. For this reason, there has been a recent emphasis on developing excitation sources capable of exciting photoinitiators with high efficiency. To achieve high efficiency, it is desirable for the emission spectrum of the excitation source to closely match one or more absorption bands of the photoinitiator so that a high fraction of the output of the excitation source is absorbed by and activates the photoinitiator.

Recent improvements in LED (light emitting diode) technology have provided high intensity light sources with narrow emission spectra. Initially, LED sources with high power were developed for the mid-long wavelength portion of the visible spectrum (e.g. wavelengths longer than ˜500 nm). LED technology, however, has advanced to the point where high intensity sources are now available at short visible and UV wavelengths. FIG. 3 illustrates the emission spectra of representative LED sources in the short wavelength visible and UVA portions of the spectrum. The emission spectra of LED sources with peak wavelengths at 365 nm, 385 nm, 395 nm, and 405 nm are illustrated. The LED sources exhibit narrow emission spectra with the peak wavelength indicated and a FWHM (full width at half maximum) of about 15 nm. Through selection of an LED source with good spectral overlap with one or more absorption bands of a photoinitiator, it becomes possible to utilize a high fraction of the output intensity of the LED source to excite the photoinitiator and to achieve high excitation efficiency. The emission spectra of UV lasers are narrower than the emission spectra of UVLEDs and similarly provide for efficient excitation of photoinitiators whose absorption bands overlap the laser emission wavelength.

In addition to suitable mechanical properties, secondary coatings for optical fibers require a surface that is amenable to handling and stable. The surface is preferably non-tacky, impermeable to atmospheric contaminants, stable with respect to oxidation, and resistant to damage from water and other external substances that may come into contact with the secondary coating. In one embodiment, suitable surface characteristics for the secondary coating are achieved by curing the surface region of the secondary coating to a greater degree than the bulk region of the secondary coating. In another embodiment, the degree of cure of the bulk region of the secondary coating is greater than the degree of cure of the surface region of the secondary coating.

Degree of Cure. Degree of cure is a measure of the extent to which the curing reaction proceeds. Before initiation of the curing reaction, the concentration of acrylate functional groups is high. As the curing reaction proceeds upon initiation, the concentration of acrylate functional groups decreases. A determination of the concentration of acrylate functional groups provides a measure of the extent of the curing reaction. The concentration of acrylate functional groups can be monitored before, after or at any time during the curing reaction.

The degree of cure was measured using the reacted Acrylate Unsaturation (% RAU) method. In the % RAU method, the concentration of acrylate functional groups is assessed by FTIR. Acrylate functional groups include a carbon-carbon double bond with a characteristic absorption frequency in the infrared centered near 810 cm⁻¹. The intensity of this characteristic acrylate band is proportional to the concentration of acrylate functional groups. As the curing reaction proceeds, the intensity of the characteristic acrylate band decreases and the magnitude of the decrease is a measure of the degree of cure at any point during the curing reaction.

% RAU was determined by measuring the area of the characteristic acrylate band at 810 cm⁻¹. The baseline for the measurement was taken as the tangent line through the absorption minima of the characteristic acrylate band. The area of the characteristic acrylate band was taken as the area of the band above the baseline. To account for background intensity and instrumental effects on the area measurement, the area of a reference band in the 750-780 cm⁻¹ region using the baseline of the characteristic acrylate band was measured. The spectral region of the reference band is outside of the absorption range of acrylate functional groups. The ratio R of the area of the characteristic acrylate band to the area of the reference band was determined. This ratio is proportional to the concentration of unreacted acrylated functional groups in the coating composition. The ratio is greatest for the coating composition before initiation of the curing reaction and decreases as the curing reaction proceeds.

% RAU is defined

$$\% RAU = \frac{( {R}_{L} - {R}_{F} ) \times 100}{{R}_{L}} \qquad ( 9 )$$

where R_{L} is the ratio R for the uncured coating composition and R_{F} is the ratio R for the cured product of the coating composition.

The degree of cure can vary in different portions of a cured product. In the present description, a distinction is made between the degree of cure in the surface region of the cured product, the degree of cure in the bulk region of the cured product, and the overall degree of cure of the cured product. The surface degree of cure refers to the average degree of cure in a region of the cured product extending from the surface to a depth of 1.5 μm and the bulk degree of cure refers to the average degree of cure in the balance of the cured product. The overall degree of cure refers to the average degree of cure over the entirety of the cured product, including the surface region and the bulk region. In some embodiments, the difference between the surface degree of cure and bulk degree of cure is less than 10%. In other embodiments, the difference between the surface degree of cure and bulk degree of cure is less than 5%. In further embodiments, the difference between the surface degree of cure and bulk degree of cure is less than 2%.

In various embodiments, the overall degree of cure of the cured product of the curable coating composition is greater than 70%, or greater than 75%, or greater than 80%, or greater than 85%, or in the range from 70%-95%, or in the range from 75%-95%, or in the range from 80%-90%

In various embodiments, the bulk degree of cure of the cured product of the curable coating composition is greater than 70%, or greater than 75%, or greater than 80%, or greater than 85%, or in the range from 70%-95%, or in the range from 75%-95%, or in the range from 80%-90%.

In various embodiments, the surface degree of cure of the cured product of the curable coating composition is greater than 75%, or greater than 80%, or greater than 85%, or greater than 90%, or in the range from 75%-100%, or in the range from 80%-95%, or in the range from 85%-90%.

The bulk modulus and other mechanical properties of the cured product are controlled by the bulk degree of cure. In order to achieve the bulk modulus and other mechanical properties needed for a secondary coating or ribbon matrix, it is often not necessary to run the curing reaction to a bulk degree of cure of 100%. A bulk degree of cure less than 100% is advantageous because it reduces processing time. The degree of cure needed for the bulk region of the cured product, however, may be insufficient to achieve the properties desired for the surface region.

One strategy for increasing the surface degree of cure relative to the bulk degree of cure for a given time of cure is to include at least two photoinitiators in the radiation-curable coating composition. In this embodiment, one photoinitiator controls the bulk degree of cure and a different photoinitiator controls the surface degree of cure. In one embodiment, the photoinitiator used for surface curing is an a-hydroxyketone compound (e.g. Irgacure 184, Irgacure 127, Darocure 1173). In another embodiment, the photoinitiator used for bulk curing is an acylphosphine oxide compound (e.g. Lucirin TPO, Irgacure 819, Irgacure 2100). In one embodiment, the curable coating composition includes the photoinitiators 2,4,6-trimethylbenzoyl-diphenylphosphine oxide (e.g. Lucirin TPO) and 1-hydroxycyclohexylphenyl ketone (e.g. Irgacure 184), where 2,4,6-trimethylbenzoyl-diphenylphosphine oxide (e.g. Lucirin TPO) controls bulk curing and 1-hydroxycyclohexylphenyl ketone (e.g. Irgacure 184) controls surface curing.

A potential complication with using multiple photoinitiators in the curable coating composition is that different photoinitiators have different absorption characteristics and typically require different excitation wavelengths. When using a broadband excitation source (e.g. Hg lamp), significant excitation intensity occurs over a wide range of wavelengths and simultaneous excitation of multiple photoinitiators with a single source is normally possible. When using an LED or laser source, however, the intensity is limited to a narrow range of wavelengths and it becomes difficult to identify a combination of photoinitiators with absorption characteristics that permit simultaneous excitation with the same LED or laser source.

In one embodiment, the present disclosure provides a curable coating composition that includes two or more radiation-curable monomers and two or more photoinitiators that can be efficiently cured with an LED or laser source. In one embodiment, the LED source is a UVLED source. The peak wavelength of the LED or laser source is a wavelength less than 410 nm, or less than 405 nm, or less than 400 nm, or less than 395 nm, or in the range from 340 nm-410 nm, or in the range from 350 nm-405 nm, or in the range from 360 nm-405 nm, or in the range from 365 nm-400 nm, or in the range from 370 nm-395 nm, or in the range from 375 nm-390 nm, or in the range from 375 nm-400 nm, or in the range from 380 nm-400 nm. The two or more photoinitiators are excited with the same LED or laser to initiate the curing reaction of the curable coating composition. In one embodiment, one photoinitiator controls curing of the bulk portion of the cured product of the curable coating composition and another photoinitiator controls the curing of the surface portion of the cured product of the curable coating composition.

In various embodiments, the bulk degree of cure of the cured product of the curable coating composition is greater than 70%, or greater than 75%, or greater than 80%, or greater than 85%, or in the range from 70%-95%, or in the range from 75%-95%, or in the range from 80%-90% and the surface degree of cure of the cured product of the curable coating composition is greater than 75%, or greater than 80%, or greater than 85%, or greater than 90%, or in the range from 75%-100%, or in the range from 80%-95%, or in the range from 85%-90%.

In various embodiments, the surface degree of cure of the cured product of the curable coating composition is greater than 70%, or greater than 75%, or greater than 80%, or greater than 85%, or in the range from 70%-95%, or in the range from 75%-95%, or in the range from 80%-90% and the bulk degree of cure of the cured product of the curable coating composition is greater than 75%, or greater than 80%, or greater than 85%, or greater than 90%, or in the range from 75%-100%, or in the range from 80%-95%, or in the range from 85%-90%

The surface degree of cure may be greater than, less than or equal to the bulk degree of cure. In various embodiments, the surface degree of cure exceeds the bulk degree of cure by at least 1%, or at least 3%, or at least 5%, or at least 10%, or by an amount in the range from 1%-20%, or by an amount in the range from 3%-15%, or by an amount in the range from 5%-10%. In other embodiments, the bulk degree of cure exceeds the surface degree of cure by at least 1%, or at least 3%, or at least 5%, or at least 10%, or by an amount in the range from 1%-20%, or by an amount in the range from 3%-15%, or by an amount in the range from 5%-10%.

In one embodiment, the monomeric component of the curable coating composition includes two or more radiation-curable alkoxylated monomers, where each of the two or more radiation-curable alkoxylated monomers has one or more radiation-curable groups. The one or more radiation-curable groups are ethylenically unsaturated groups. Ethylenically unsaturated groups include acrylate groups and methacrylate groups. The degree of alkoxylation of a radiation-curable alkoxylated monomer is in the range from 2-9, or in the range from 3-9, or in the range from 4-8, or greater than 10, or greater than 20, or in the range from 10-50, or in the range from 10-40, or in the range from 10-30, or in the range from 10-20, or in the range from 30-50.

In one embodiment, the two or more radiation-curable alkoxylated monomers differ in the degree of alkoxylation. In various embodiments, the monomeric component includes a radiation-curable alkoxylated monomer having a degree of alkoxylation in the range from 2-9 and a radiation-curable alkoxylated monomer having a degree of alkoxylation greater than 10; or a radiation-curable alkoxylated monomer having a degree of alkoxylation in the range from 3-9 and a radiation-curable alkoxylated monomer having a degree of alkoxylation greater than 10; or a radiation-curable alkoxylated monomer having a degree of alkoxylation in the range from 4-8 and a radiation-curable alkoxylated monomer having a degree of alkoxylation greater than 10.

In various embodiments, the monomeric component includes a radiation-curable alkoxylated monomer having a degree of alkoxylation in the range from 2-9 and a radiation-curable alkoxylated monomer having a degree of alkoxylation greater than 20; or a radiation-curable alkoxylated monomer having a degree of alkoxylation in the range from 3-9 and a radiation-curable alkoxylated monomer having a degree of alkoxylation greater than 20; or a radiation-curable alkoxylated monomer having a degree of alkoxylation in the range from 4-8 and a radiation-curable alkoxylated monomer having a degree of alkoxylation greater than 20.

In various embodiments, the monomeric component includes a radiation-curable alkoxylated monomer having a degree of alkoxylation in the range from 2-9 and a radiation-curable alkoxylated monomer having a degree of alkoxylation in the range from 10-40; or a radiation-curable alkoxylated monomer having a degree of alkoxylation in the range from 3-9 and a radiation-curable alkoxylated monomer having a degree of alkoxylation in the range from 10-40; or a radiation-curable alkoxylated monomer having a degree of alkoxylation in the range from 4-8 and a radiation-curable alkoxylated monomer having a degree of alkoxylation in the range from 10-40.

In various embodiments, the radiation-curable alkoxylated monomer having the lower degree of alkoxylation is present in the coating composition in an amount in the range from 40 wt %-90 wt %, or in the range from 45 wt %-85 wt %, or in the range from 55 wt %-75 wt % and the radiation-curable alkoxylated monomer having the higher degree of alkoxylation is present in the coating composition in an amount in the range from 5 wt %-40 wt %, or in the range from 10 wt %-35 wt %, or in the range from 10 wt %-30 wt %.

In one embodiment, the monomeric component of the curable coating composition includes ethoxylated (4) bisphenol-A diacrylate monomer present in an amount from 50 wt %-90 wt %, more preferably from 60 wt %-80 wt %, and most preferably from 70 wt %-75 wt %; ethoxylated(30) bisphenol-A diacrylate monomer present in an amount from 5 wt %-20 wt %, more preferably from 7 wt %-15 wt %, and most preferably from 8 wt %-12 wt %; and epoxy diacrylate monomer present in an amount from 5 wt %-25 wt %, more preferably from 10 wt %-20 wt %, and most preferably from 12 wt %-18 wt %. The curable coating composition optionally includes an oligomer. In one embodiment, the curable coating composition is devoid of an oligomer. In other embodiments, the total oligomer content in the curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %.

In another embodiment, the monomeric component of the curable coating composition includes ethoxylated (4) bisphenol-A diacrylate monomer present in an amount from 30 wt %-80 wt %, more preferably from 40 wt %-70 wt %, and most preferably from 50 wt %-60 wt %; ethoxylated (10) bisphenol-A diacrylate monomer present in an amount from about 10 wt %-50 wt %, more preferably from 20 wt %-40 wt %, and most preferably from 25 wt %-35 wt %; and epoxy diacrylate monomer present in an amount from 5 wt %-25 wt %, more preferably from 10 wt %-20 wt %, and most preferably from 12 wt %-18 wt %. The curable coating composition optionally includes an oligomer. In one embodiment, the curable coating composition is devoid of an oligomer. In other embodiments, the total oligomer content in the curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %.

In a further embodiment, the monomeric component of the curable coating composition includes ethoxylated (4) bisphenol-A diacrylate monomer present in an amount from 40 wt %-80 wt %, more preferably from 60 wt %-70 wt %; ethoxylated (10) bisphenol-A diacrylate monomer in an amount from 1 wt %-30 wt %, more preferably from 5 wt %-10 wt %; ethoxylated(30) bisphenol-A diacrylate monomer present in an amount from 5 wt %-20 wt %, more preferably from 7 wt %-15 wt %; and epoxy diacrylate monomer present in an amount of from 5 wt %-25 wt %, more preferably from 10 wt %-20 wt %. The curable coating composition optionally includes an oligomer. In one embodiment, the curable coating composition is devoid of an oligomer. In other embodiments, the total oligomer content in the curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %.

In yet a further embodiment, the monomeric component of the curable coating composition includes ethoxylated (10) bisphenol A diacrylate monomer in an amount from 10 wt %-50 wt %, tripropylene glycol diacrylate monomer in an amount from 5 wt %-40 wt %, ethoxylated (4) bisphenol A diacrylate monomer in an amount from 10 wt %-55 wt % and epoxy diacrylate monomer in an amount up to 15 wt %. The curable coating composition optionally includes an oligomer. In one embodiment, the curable coating composition is devoid of an oligomer. In other embodiments, the total oligomer content in the curable coating composition is less than 3.0 wt %, or less than 2.0 wt %, or less than 1.0 wt %, or in the range from 0 wt %-3.0 wt %, or in the range from 0.1 wt %-3.0 wt %, or in the range from 0.2 wt %-2.0 wt %, or in the range from 0.3 wt %-1.0 wt %.

In another embodiment, the monomer component of the curable coating composition includes 40 wt %-80 wt % of ethoxylated (4) bisphenol A diacrylate monomer, from 0 wt %-30 wt % of ethoxylkated (10) bisphenol A diacrylate monomer, from 0 wt %-25 wt % of ethoxylated (30) bisphenol A diacrylate monomer, from 5 wt %-18 wt % of epoxy diacrylate monomer, and from 0 wt % to 10 wt % of tricyclodecane dimethanoldiacrylate monomer. The epoxy diacrylate monomer may be bisphenol A epoxy diacrylate. The curable coating composition optionally includes an oligomer. In one embodiment, the curable coating composition is devoid of an oligomer. In other embodiments, the total oligomer content in the curable coating composition is less than 3.0 wt %, or less than 2.0 wt %, or less than 1.0 wt %, or in the range from or in the range from 0 wt %-3.0 wt %, 0.1 wt %-3.0 wt %, or in the range from 0.2 wt %-2.0 wt %, or in the range from 0.3 wt %-1.0 wt %.

The present methods include applying the radiation-curable coating compositions disclosed herein to a glass fiber or to a coating or coating composition in contact with a glass fiber. In various embodiments, the radiation-curable coating composition is applied to the glass fiber when the glass fiber is in motion at a speed of greater than 30 m/s, or greater than 35 m/s, or greater than 40 m/s, or greater than 45 m/s, or greater than 50 m/s. In one embodiment, the radiation-curable coating composition is directly applied to a glass fiber. In another embodiment, another coating composition or coating is in contact with the glass fiber and the present radiation-curable coating composition is applied to the other coating composition or coating. In one embodiment the other coating composition or coating is a primary coating composition or primary coating and the present radiation-curable coating composition is a secondary coating composition. The method may also include applying a coating composition or coating to the present radiation-curable coating composition or cured product thereof. In one embodiment, the coating composition or coating applied to the present radiation-curable coating composition or cured product thereof is an ink composition or ink coating. In embodiments, the method includes curing the present radiation-curable coating composition or other coating compositions applied to a glass fiber.

### EXAMPLES

In the following examples, six glass fibers with a diameter of 125 μm were coated while in motion in a fiber draw process. The six coated glass fibers are referred to as Fiber Samples 1-6. The fibers were drawn from a preform situated in a draw furnace and were directed to a coating stage. The glass fibers were first coated with a primary coating by applying a primary coating composition to the glass fibers and curing the primary coating composition to form a primary coating. A secondary coating composition in accordance with the present description was then applied to the primary coating and cured to form a secondary coating. Various trials were conducted in which curing of the primary and secondary coating compositions was accomplished with Hg lamps or LED sources. The degree of cure and in situ modulus of the primary and secondary coatings were determined. Results obtained by curing with an Hg lamp were compared to results obtained with an LED source.

The primary coating composition used for Fiber Samples 1-4 included the components listed in Table 1. The primary coating composition used for Fiber Samples 5 and 6 was a proprietary commercial formulation (available from Hampford Research or Penn Color).

TABLE 1
Primary Coating Composition

| Component | Amount | |
|---|---|---|
| Oligomer | 50.0 | wt % |
| SR504 | 46.5 | wt % |
| NVC | 2.0 | wt % |
| Lucirin TPO | 1.5 | wt % |
| Irganox 1035 | 1 | pph |
| (3-acryloxypropyl)trimethoxysilane | 0.8 | pph |
| Tetrathiol | 0.03 | pph |

The oligomer is an aliphatic urethane acrylate oligomer formed from a reaction of 2-hydroxyethyl acrylate, 4,4′-methylenebis(cyclohexyl isocyanate), and polypropylene glycol (molecular weight ˜4000 g/mol), and having the formula

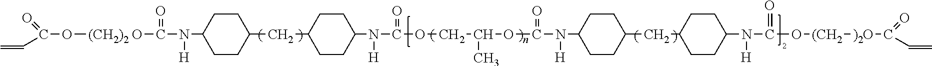

where n˜70. SR504 is ethoxylated(4)nonylphenol acrylate (a monomer). NVC is N-vinylcaprolactam (a monomer). Lucirin TPO is 2,4,6-trimethylbenzoyl)diphenyl phosphine oxide) (a photoinitiator). Irganox 1035 is thiodiethylene bis(3,5-di-tert-butyl)-4-hydroxyhydrocinnamate (an antioxidant). (3-acryloxypropyl)trimethoxysilane is an adhesion promoter. Tetrathiol is pentaerythritol tetrakis(3-mercaptopropionate) (a chain transfer agent).

The secondary coating composition for Fiber Samples 1-4 were devoid of oligomer and included the components listed in Table 2. The secondary coating composition for Fiber Samples 5 and 6 was a proprietary commercial formulation (available from Elantas).

TABLE 2
Secondary Coating Composition

| Component | Amount | |
|---|---|---|
| SR601 | 72.0 | wt % |
| CD9038 | 10.0 | wt % |
| Photomer 3016 | 15.0 | wt % |
| Lucirin TPO | 1.5 | wt % |
| Irgacure 184 | 1.5 | wt % |
| Irganox 1035 | 0.5 | pph |
| DC190 | 1 | pph |

SR601 is ethoxylated (4) bisphenol A diacrylate (a monomer). CD9038 is ethoxylated (30)bisphenol A diacrylate (a monomer). Photomer 3016 is bisphenol A epoxy diacrylate (a monomer). Lucirin TPO is 2,4,6-trimethylbenzoyl)diphenyl phosphine oxide) (a photoinitiator). Irgacure 184 is 1-hydroxycyclohexylphenyl ketone (a photoinitiator). Irganox 1035 is thiodiethylene bis(3,5-di-tert-butyl)-4-hydroxyhydrocinnamate (an antioxidant). DC190 is silicone-ethylene oxide/propylene oxide copolymer (a slip agent).

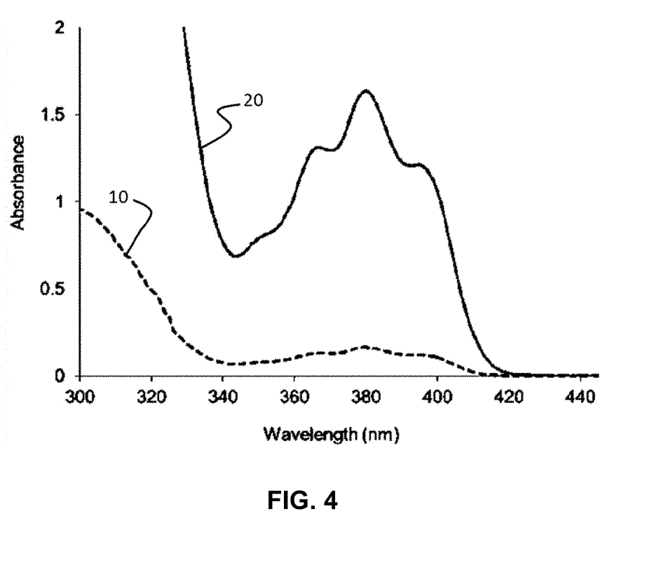

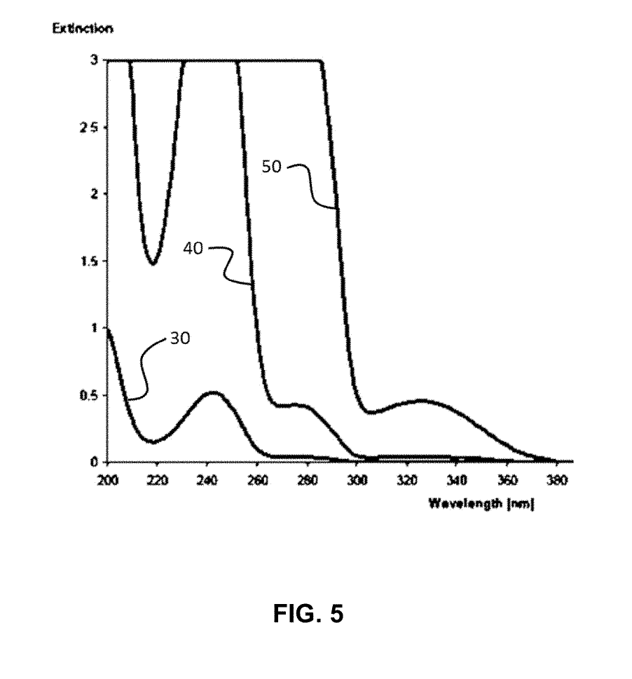

The absorption spectra of the photoinitiators Lucirin TPO and Irgacure 184 are shown in FIGS. 4 and 5, respectively. In FIG. 4, trace 10 shows the absorption spectrum of Lucirin TPO at a concentration of 0.01 wt % in ethanol and trace 20 shows the absorption spectrum of Lucirin TPO at a concentration of 0.10 wt % in ethanol. In FIG. 5, trace 30 shows the absorption spectrum of Irgacure 184 at a concentration of 0.001 wt % in acetonitrile, trace 40 shows the absorption spectrum of Irgacure 184 at a concentration of 0.01 wt % in acetonitrile, and trace 50 shows the absorption spectrum of Irgacure 184 at a concentration of 0.10 wt % in acetonitrile.

The primary and secondary coating compositions of Fiber Sample 1 and Fiber Sample 5 were cured with Hg lamps (Fusion UV Model 1250 lamps (manufactured by Heraeus Noblelight Fusion UV) equipped with a D bulb (10-inch, 375 W/inch).

The primary and secondary coating compositions of Fiber Samples 2, 3, 4, and 6 were cured with LED sources. The LED sources were manufactured by Phoseon, Inc. and each LED source had peak output power of 20 W/cm². The wavelengths of LED sources are listed in Table 3. The wavelengths listed correspond to the peak wavelength of emission from the LED source. The LED sources each had a FWHM of about 15 nm. The lamp/speed ratio listed in Table 3 is an indication of the UV radiation dose provided to the optical fiber during curing. Lamp/speed ratio as used herein is defined as the ratio of the number of radiation curing LED sources (or Hg lamps) to the draw speed of the optical fiber in meters/second. For example, a draw tower that operates at a draw speed of 15 m/s with 3 LED sources for the primary coating and 3 LED sources for the secondary coating has a lamp/speed ratio of 6/15=0.4. The lamp/speed ratios for Fiber Samples 1 and 5 were 0.24 and 0.21, respectively.

TABLE 3
LED Wavelengths for Curing - Fiber Samples 2, 3, 4, and 6

| | Wavelength of | Wavelength of | |
|---|---|---|---|
| Fiber | LED Sources | LED sources | Lamp/Speed |
| Sample | (Primary) | (Secondary) | Ratio |
| 2 | 395 nm | 385 nm | 0.24 |
| 3 | 395 nm | 385 nm | 0.29 |
| 4 | 395 nm | 365 nm | 0.24 |
| 6 | 395 nm | 385 nm | 0.34 |

After curing, the overall degree of cure and in situ modulus of the primary and secondary coatings were measured. The overall degree of cure was determined by measuring % RAU using the FTIR method described above.

For primary coatings, the in situ modulus was measured using the following procedure. A six-inch sample of a coated fiber sample was obtained and a one-inch section from the center of the fiber sample was window stripped and wiped with isopropyl alcohol. The window-stripped fiber sample was mounted on a sample holder/alignment stage equipped with 10 mm×5 mm rectangular aluminum tabs that were used to affix the fiber sample. Two tabs were oriented horizontally and positioned so that the short 5 mm sides were facing each other and separated by a 5 mm gap. The window-stripped fiber sample was laid horizontally on the sample holder across the tabs and over the gap separating the tabs. The coated end of one side of the window-stripped region of the fiber sample was positioned on one tab and extended halfway into the 5 mm gap between the tabs. The one-inch window-stripped region extended over the remaining half of the gap and across the opposing tab. After alignment, the fiber sample was moved and a small dot of glue was applied to the half of each tab closest to the 5 mm gap. The fiber sample was then returned to position and the alignment stage was raised until the glue just touched the fiber sample. The coated end was then pulled away from the gap and through the glue such that the majority of the 5 mm gap between the tabs was occupied by the window-stripped region of the fiber sample. The portion of the window-stripped region remaining on the opposing tab was in contact with the glue. The very tip of the coated end was left to extend beyond the tab and into the gap between the tabs. This portion of the coated end was not embedded in the glue and was the object of the in situ modulus measurement. The glue was allowed to dry with the fiber sample in this configuration to affix the fiber sample to the tabs. After drying, the length of fiber sample fixed to each of the tabs was trimmed to 5 mm. The coated length embedded in glue, the non-embedded coated length (the portion extending into the gap between the tabs), and the primary diameter were measured.

The in situ modulus measurements for the primary coatings were performed on a Rheometrics DMTA IV dynamic mechanical testing apparatus at a constant strain of 9×10⁻⁶ l/s for a time of forty-five minutes at room temperature (21° C.). The gauge length was 15 mm. Force and delta length were recorded and used to calculate the in situ modulus of the primary coating. The tab-mounted fiber samples were prepared by removing any epoxy from the tabs that would interfere with the 15 mm clamping length of the testing apparatus to insure that there was no contact of the clamps with the fiber and that the sample was secured squarely to the clamps. The instrument force was zeroed out. The tab to which the non-coated end of the fiber sample was affixed was then mounted to the lower clamp (measurement probe) of the testing apparatus and the tab to which the coated end of the fiber sample was affixed was mounted to the upper (fixed) clamp of the testing apparatus. The test was then executed and the fiber sample was removed once the analysis was completed.

For secondary coatings, the in situ modulus was measured using coating tube-off samples prepared from the fiber samples. A 0.0055 inch miller stripper was clamped down approximately 1 inch from the end of the fiber sample. This one-inch region of fiber sample was immersed into a stream of liquid nitrogen and held for 3 seconds. The fiber sample was then removed and quickly stripped. The stripped end of the fiber sample was then inspected. If coating remained on the glass portion of the fiber sample, the tube-off sample was deemed defective and a new tube-off sample was prepared. A proper tube-off sample is one that stripped clean from the glass and consisted of a hollow tube with primary and secondary coating. The glass, primary and secondary coating diameter were measured from the end-face of the un-stripped fiber sample.

The fiber tube-off samples were run using a Rheometrics DMTA IV instrument at a sample gauge length 11 mm to obtain the in situ modulus of the secondary coating. The width, thickness, and length were determined and provided as input to the operating software of the instrument. The sample was mounted and run using a time sweep program at ambient temperature (21° C.) using the following parameters:
Frequency: 1 Rad/sec
Strain: 0.3%
Total Time=120 sec.
Time Per Measurement=1 sec
Initial Static Force=15.0 g
Static>Dynamic Force by=10.0%
   Once completed, the last five E′ (storage modulus) data points were averaged. Each sample was run three times (fresh sample for each run) for a total of fifteen data points. The averaged value of the three runs was reported.

The overall degree of cure and in situ modulus of the primary and secondary coatings of Fiber Samples 1, 2, 4, 5, and 6 are shown in Table 4. Standard deviations are listed for in situ modulus measurements of three specimens of each fiber sample. The specimens had length ˜1 cm and were separated by ˜1 m along the fiber sample. Standard deviations for the overall degree of cure measurements were low (0.03-0.20) and are not reported.

TABLE 4
Overall Degree of Cure and In Situ Modulus

| | Overall | | Overall | |
|---|---|---|---|---|
| | Degree of | In Situ Modulus | Degree of | In Situ Modulus |
| Fiber | Cure (%) | (MPa) | Cure (%) | (MPa) |
| Sample | (Primary) | (Primary) | (Secondary) | (Secondary) |
| 1 | 90.9 | 0.146 ± 0.016 | 94.5 | 1817 ± 32 |
| 2 | 92.9 | 0.130 ± 0.004 | 92.2 | 1711 ± 23 |
| 4 | 96.8 | 0.260 ± 0.033 | 89.9 | 1917 ± 38 |
| 5 | 89.5 | 0.294 ± 0.007 | 93.4 | 1292 ± 32 |
| 6 | 88.0 | 0.281 ± 0.017 | 76.5 | 573 ± 34 |

The in situ modulus of the cured product of embodiments of the curable coating composition disclosed herein under the test conditions disclosed herein is greater than 1200 MPa, or greater than 1400 MPa, or greater than 1600 MPa, or greater than 1800 MPa, or in the range from 1200 MPa-2000 MPa, or in the range from 1400 MPa-1900 MPa, or in the range from 1500 MPa-1900 MPa.

The results shown in Table 4 indicate that secondary coatings formed by curing secondary coating compositions in accordance with the present disclosure exhibit similar overall degree of cure and in situ modulus properties when cured with LED sources and Hg lamps.

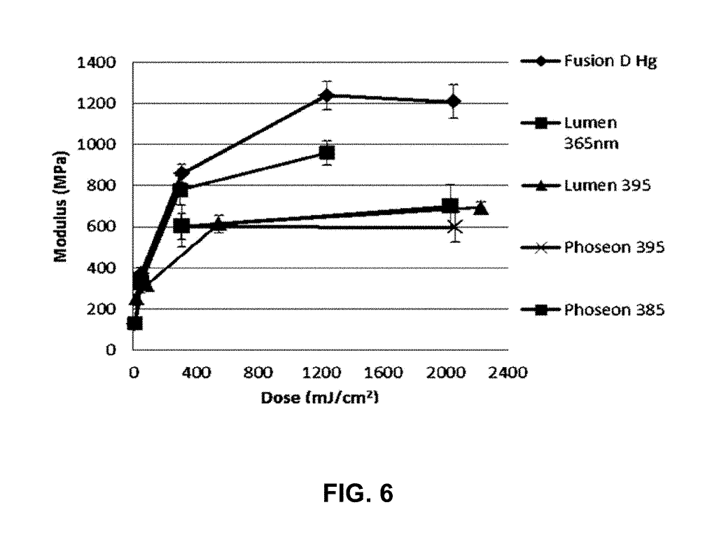

The similarity of properties of the secondary coatings on fibers was unexpected and counterintuitive based on preliminary ex situ measurements made on film samples formed by curing the secondary coating composition. FIG. 6 shows dose-modulus curves for cured film samples of the secondary coating composition listed in Table 2. Films were prepared by drawing down the formulations on glass slide using a 5 mil draw down bar. Films were cured under a nitrogen purge using a Fusion D lamp as a control or Lumen and Phoseon 365 nm, 385 nm or 395 nm UV LED lamps (These were retrofitted on the curing belt for experimental use). The films received varying doses measured with International Light ILT 490 light bug. The dose was adjusted preferentially by changing the belt speed, however, when using the Fusion D lamp for very low doses, a 2″ square 1.5 neutral density filter by Newport (FSq-ND15) was used to attenuate the light. Lower doses on UV LED lamps were achieved by decreasing the intensity of the lamp. All samples were allowed to condition overnight in a humidity chamber (approximately 23C, 50% relative humidity). The dose-modulus curves show the evolution of the Young's modulus of the cured films as a function of irradiation dose from several excitation sources. The excitation sources included a Hg lamp and several LED sources. The results indicate that excitation with an Hg lamp provided cured films with superior properties (higher Young's modulus) relative to films cured with any of the LED sources. Since high Young's modulus is a desirable feature for secondary coatings, the results of FIG. 6 indicate that inferior secondary coatings are expected upon LED curing. Contrary to the expectations of FIG. 6, however, properties for secondary coatings formed by curing with an LED source on a fiber during draw were comparable to and not inferior to the properties obtained when curing with an Hg lamp.

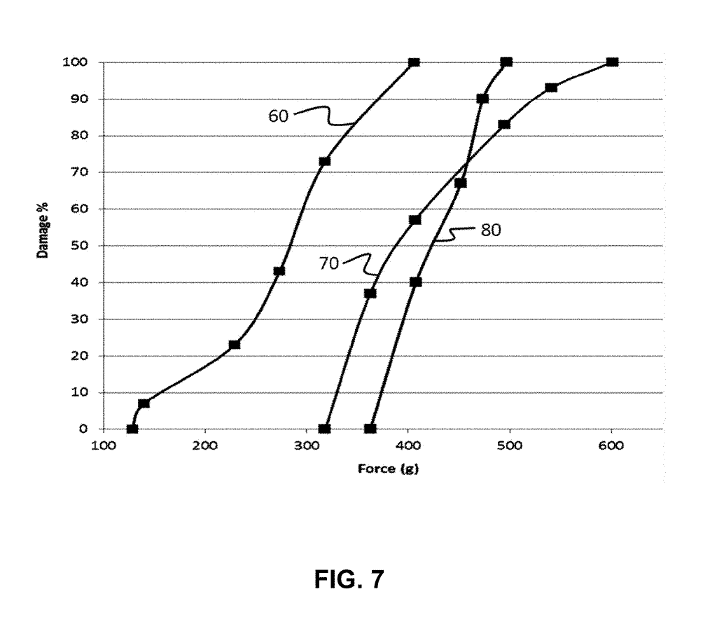

A further unexpected advantage of curing with an LED source relative to curing with an Hg lamp is presented in FIG. 7. FIG. 7 shows damage to the secondary coating as a function of load force for Fiber Sample 1 (trace 60), Fiber Sample 2 (trace 70), and Fiber Sample 3 (trace 80). In the damage test, a fiber sample is subjected to a compressive load force at 10 different sites along the secondary coating. The full test procedure is described in an article entitled “Mechanics of Delamination Resistance Testing” published in the Proceedings of the 47^{th} International Wire & Cable Symposium, pp. 725-730 (1998). The regions of the fiber sample subjected to the compressive load force are visually examined with a microscope to detect the number of sites damaged by the compressive load force. The Damage % shown in FIG. 7 corresponds to the ratio of the number of damaged sites to the total number of sites (10) subjected to the compressive load force. Damage can be expressed in terms of a static damage resistance parameter for a specified Damage %. The 50% static damage resistance, for example, corresponds to the compressive load force required to cause damage at a level of Damage %=50%. The 0% static damage resistance corresponds to the highest compressive load force that a coating can withstand while exhibiting no damage (Damage %=0). The results indicate that the secondary coating exhibits much higher static damage resistance when cured with LED sources than when cured by an Hg lamp. The same secondary coating composition was applied to each of Fiber Samples 1, 2, and 3 and the data shown in FIG. 7 indicates that when cured with an Hg lamp, the secondary coating has a 0% static damage resistance of about 125 g and a 50% static damage resistance of about 280 g, and that when cured with an LED source, the secondary coating has a 0% static damage resistance over 300 g and a 50% static damage resistance over 350 g.

Cured products prepared from curable coating compositions disclosed herein have a 0% static damage resistance greater than 150 g, or greater than 200 g, or greater than 250 g, or greater than 300 g, or in the range from 150 g-400 g, or in the range from 200 g-375 g, or in the range from 250 g-350 g. Cured products prepared from curable coating compositions disclosed herein have a 50% static damage resistance greater than 300 g, or greater than 325 g, or greater than 350 g, or greater than 375 g, or in the range from 300 g-450 g, or in the range from 325 g-425 g, or in the range from 350 g-450 g.

Still another unexpected advantage associated with curing using an LED source relative to an Hg source is a greater adhesion of an ink layer to the secondary coating. To distinguish individual optical fibers in a cable bundle, it is common to apply a colored ink layer to the secondary coating. Each fiber in a bundle is colored with a unique ink layer so that individual fibers can be identified. The layer is the cured product of a curable coating composition that includes a pigment. A wide variety of pigments are available to provide a range of colors for optical fibers. To provide reliable identification, good adhesion is needed between the ink layer and the secondary coating.

Fibers 1, 2 and 6 were colored with an ink layer (pigmented coating). Ten specimens of each of Fiber Samples 1 and 2, and eleven specimens of Fiber Sample 6 were tested for ink adhesion. An ink layer was applied to the secondary coating of ten specimens of each of Fiber Samples 1 and 2, and eleven specimens of Fiber Sample 4. Adhesion of the ink layer to the secondary coating was tested by pulling on the ink layer with a constant force and determining the condition of the fiber sample at the conclusion of the test. The ink adhesion test involves casting a 20 mil film of matrix coating (similar to the matrix described as Example 1 in Table 4 of U.S. Published Patent Application No. 20160299305) over one end of the fiber and curing it. The fiber is then pulled out of the matrix using a tensile tester at a rate of 0.5 mm/min. The failure mode and peak force are recorded. The failure modes that can be observed are break out or coating fully pulling out of the matrix coating, the coating partially adhering to the matrix coating and the coating fully adhering to the matrix coating. The specimens of the fiber samples were classified under one of three test conditions: whether the ink layer remained fully adhered to the secondary coating, partially adhered to the secondary coating, or was stripped completely from the secondary coating. Table 5 shows the test results for specimens of each fiber sample at different force loads. The number of specimens exhibiting each of the three test conditions relative to the total number of specimens is listed.

TABLE 5
Adhesion of Ink Layer to Secondary Coating

| | Peak | | | |
|---|---|---|---|---|
| Fiber | Pulling | Full | Partial | |
| Sample | Force (lb_{f}) | Adhesion | Adhesion | Strip Off |
| 1 | 3.569 | 5/10 | 3/10 | 2/10 |
| 2 | 2.354 | 7/10 | 3/10 | 0/10 |
| 6 | 1.852 | 7/11 | 3/11 | 0/10 |

The results indicate specimens of Fiber Samples 2 and 4 exhibit much stronger adhesion of the ink layer to the secondary coating than the specimens of Fiber Sample 1. Curing of the secondary coating composition with a LED sources produces a secondary coating having greater adhesion to the ink layer than curing the same secondary coating composition with an Hg lamp.

The results shown in Table 4 also indicate that benefit of including multiple photoinitiators in the secondary coating composition. Although the commercial secondary coating composition for Fiber Sample 6 is proprietary, it is known that it includes Irgacure 184 as the sole photoinitiator. The results in Table 4 indicate that the degree of cure and in situ modulus of the secondary coating of Fiber Sample 6 was much lower than for Fiber Samples 2 and 3, which had secondary coatings formed from a secondary coating composition that included Lucirin TPO in addition to Irgacure 184 as a photoinitiator and which were excited with the same LED sources as Fiber Sample 6. The results demonstrate the advantage of including multiple photoinitiators in a secondary coating composition when curing using LED sources.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method for manufacturing an optical fiber comprising:
applying a first coating composition to a glass fiber, said first coating composition comprising:
two or more radiation-curable monomers;
an oligomer, said oligomer having a concentration in the range from 0 wt %-3 wt % in said coating composition; and
a photoinitiator; and
curing said first coating composition with a light emitting diode, said light emitting diode having an emission spectrum with a peak wavelength in the range from 360 nm-410 nm, said curing forming a cured product having an overall degree of cure greater than 80%.

2. The method of claim 1, wherein said two or more radiation-curable monomers include an alkoxylated bisphenol A diacrylate monomer.

3. The method of claim 1, wherein said two or more radiation-curable monomers include a first alkoxylated bisphenol A diacrylate monomer having a first degree of alkoxylation and a second alkoxylated bisphenol A diacrylate monomer having a second degree of alkoxylation, said second degree of alkoxylation differing from said first degree of alkoxylation.

4. The method of claim 3, wherein said first degree of alkoxylation is in the range from 3-9.

5. The method of claim 4, wherein said second degree of alkoxylation is in the range from 10-40.

6. The method of claim 3, wherein said first alkoxylated bisphenol A diacrylate monomer is an ethoxylated bisphenol A diacrylate monomer.

7. The method of claim 6, wherein said second alkoxylated bisphenol A diacrylate monomer is an ethoxylated bisphenol A diacrylate monomer.

8. The method of claim 7, wherein said first alkoxylated bisphenol A diacrylate monomer has a degree of ethoxylation in the range from 3-9 and is present in said first coating composition in an amount in the range from 45 wt %-85 wt %.

9. The method of claim 8, wherein said second alkoxylated bisphenol A diacrylate monomer has a degree of ethoxylation in the range from 10-40 and is present in said first coating composition in an amount in the range from 5 wt %-40 wt %.

10. The method of claim 9, wherein first alkoxylated bisphenol A diacrylate is present in said first coating composition in an amount in the range from 55 wt %-75 wt % and said second alkoxylated bisphenol A diacrylate monomer is present in said first coating composition in an amount in the range from 10 wt %-30 wt %.

11. The method of claim 3, wherein said two or more radiation-curable monomers further includes an epoxy diacrylate monomer.

12. The method of claim 1, wherein said concentration of said oligomer is less than 1 wt %.

13. The method of claim 1, wherein said first coating composition is devoid of urethane oligomers.

14. The method of claim 1, wherein said first coating composition includes at least two photoinitiators.

15. The method of claim 14, wherein said at least two photoinitiators include a first photoinitiator and a second photoinitiator, said first photoinitiator having a first integrated absorption intensity in the range from 380 nm-410 nm in said first coating composition and said second photoinitiator having a second integrated absorption intensity in the range from 380 nm-410 nm in said first coating composition, said first normalized integrated intensity being at least ten times greater than said second normalized integrated intensity.

16. The method of claim 1, wherein said cured product has an in situ modulus in the range from 1400 MPa-1900 MPa.

17. The method of claim 1, wherein said cured product has a 50% static damage resistance greater than 300 g.

18. The method of claim 1, wherein said cured product has a 0% static damage resistance greater than 150 g.

19. The method of claim 1, wherein said cured product lacks urethane groups.

20. The method of claim 1, wherein said glass fiber is moving at a speed greater than 40 m/s.

21. The method of claim 1, further comprising drawing said glass fiber from a preform.

22. The method of claim 1, further comprising applying a second coating composition to said glass fiber.

23. The method of claim 22, wherein said first coating composition is applied to said second coating composition or to a cured product of said second coating composition.

24. The method of claim 1, further comprising applying a second coating composition to said first coating composition or to said cured product of said first coating composition, said second coating composition comprising a pigment.
